(19) United States
(12) Patent Application Publication
(10) Pub. No.: US 2008/0006333 A1
(43) Pub. Date: Jan. 10, 2008

(54) Structure of a fuel tank for a multi-fuel system

(75) Inventors: Randall D. Partridge, Annandale, NJ (US); Kouseki Sugiyama, Susono-shi (JP); Tomihisa Oda, Numazu-shi (JP); Keiji Yoeda, Numazu-shi (JP); Yoshihiro Iwashita, Mishima-shi (JP)

Correspondence Address: OLIFF & BERRIDGE, PLC, P.O. BOX 320850, ALEXANDRIA, VA, 22320-4850, US

(73) Assignees: ExxonMobil Research and Engineering Company, Annandale, NJ (US); Toyota Jidosha Kabushiki Kaisha, Toyota-shi (JP)

(21) Appl. No.: 11/475,151

(22) Filed: Jun. 27, 2006

(51) Int. Cl. E03B 11/00; F17D 1/00

(52) U.S. Cl. 137/571

(57) ABSTRACT

A multi-fuel system includes a high vapor pressure fuel tank and a low vapor pressure fuel tank. The high vapor pressure fuel tank contains a fuel a saturated vapor pressure of which is high so that the concentration of fuel vapor in a vapor space of the tank in the normal temperature range becomes higher than an upper-limit of an ignitable concentration of vapor. The low vapor pressure fuel tank contains a fuel a saturated vapor pressure of which is low so that the concentration of a fuel vapor in vapor space of the tank in the normal temperature range becomes lower than the upper-limit of an ignitable concentration of vapor. The vapor space in the high vapor pressure fuel tank communicates with the vapor space in the low vapor pressure fuel tank through a communication pipe, and the vapor space in the low vapor pressure fuel tank is connected to canister 15 through a vapor pipe and a check valve. Fuel vapor of a high vapor pressure in the high vapor pressure fuel tank flows through the communication pipe into the low vapor pressure fuel tank to fill the same. Therefore, the fuel concentration in the vapor space in the low vapor pressure fuel tank becomes higher than the upper-limit concentration in the ignitable range.

### BACKGROUND OF THE INVENTION

1. Field of the Invention

The present invention relates to a structure of a fuel tank. More specifically, the invention relates to the structure of a fuel tank used for a multi-fuel system that uses a plurality of fuels having different saturated vapor pressures.

2. Description of the Related Art

In a fuel tank storing a liquid fuel, the vapor of a fuel that has evaporated stays in the vapor space in the tank (in this specification, the term “vapor space” means the space in the tank above the liquid fuel level). A partial pressure of the fuel vapor (concentration of fuel vapor) in the vapor space becomes equal to a saturated vapor pressure of fuel at a tank temperature.

In a fuel tank in which the vapor space communicates with the atmosphere, therefore, a mixture of air and fuel is formed in the vapor space. The fuel concentration of the mixture of the fuel and the air becomes high as the saturated vapor pressure increases. Depending upon the saturated vapor pressure of fuel, therefore, in some cases, the fuel vapor concentration of the mixture in the vapor space in the tank may enter an ignitable range. This may become a problem from the standpoint of safety.

Referring, for example, to a fuel tank of a vehicle, it is said that a range of ignitable concentrations of the vapor of the commercially available regular gasoline is from about 0.6 to about 8.0 vol %. If the concentration of gasoline vapor in the fuel tank lies in this ignitable range, it is possible that the gasoline vapor will catch fire in the tank.

However, regular gasoline has a relatively high saturated vapor pressure, and hence the concentration of gasoline vapor in the fuel tank seldom becomes lower than the upper-limit value (8.0%) of the ignitable concentration at normal temperature, and thus there is little probability that the gasoline vapor will catch fire in the fuel tank.

Generally, however, the saturated vapor pressure of gasoline decreases as the octane value thereof increases if the temperature thereof is the same. In the case of high-octane gasoline having an octane value higher than that of regular gasoline, therefore, the saturated vapor pressure becomes low and, hence, the concentration of gasoline vapor in the tank may enter the range of ignitable concentration even in a range of normal temperature.

In the case of commercially available high-octane gasoline, therefore, the components are usually adjusted in advance to increase the saturated vapor pressure at normal temperature without lowering the octane value as a whole, so that in a range of normal temperature, the concentration of gasoline vapor in the fuel tank does not become lower than the upper-limit of ignitable concentration at any time.

There has heretofore been known an onboard fuel separation system which separates commercially available regular gasoline into a low-octane gasoline having a low octane value and a high-octane gasoline having a high octane value.

A fuel separation system of this kind is disclosed in, for example, International Patent Publication No. 2004-522039 and Japanese Unexamined Patent Publication (Kokai) No. 2004-232624.

According to the onboard fuel separation systems disclosed in the '039 and '624 publications, commercially available gasoline is separated by using a separation membrane, and the low-octane gasoline and the high-octane gasoline that are formed are each stored in dedicated tanks. The low-octane gasoline and the high-octane gasoline are then fed to the engine, depending upon the operating conditions.

By using the onboard fuel separation system as described above, it is made possible to use the gasoline of an octane value that meets the operating conditions without the need for it to be separately fed with low-octane gasoline and high-octane gasoline from an external supply source.

However, there arises a problem when there are formed gasolines of different octane values by using the onboard fuel separation system as disclosed in '039 and '624 publications.

In general, the saturated vapor pressure of gasoline decreases with an increase in the octane value thereof, as described above.

When the low-octane gasoline and the high-octane gasoline separated by the onboard fuel separation system are stored in separate tanks, therefore, in some cases, the concentration of fuel vapor becomes lower than the upper-limit of ignitable concentration in the tank containing the high-octane gasoline, even in the range of normal temperature, since the saturated vapor pressure therein is low, and sometimes falls in the range of ignitable concentration.

In the case of commercially available high-octane gasoline, as described above, the components are adjusted in advance in order to increase the saturated vapor pressure without lowering the octane value so that the concentration of gasoline vapor in the tank is maintained at a value higher than the upper-limit of an ignitable concentration. When the onboard fuel separation system is used as taught in '039 and '624 publications, however, it becomes difficult to adjust the components so as to increase the saturated vapor pressure without lowering the octane value. In a high-octane gasoline tank, therefore, it is difficult to maintain the concentration of the fuel vapor at values higher than the upper-limit of the range of ignitable concentration.

In a multi-fuel system for forming a plurality of fuels having different octane values by using an onboard fuel separation system, therefore, there is necessarily formed a fuel having a low saturated vapor pressure, and the concentration of fuel vapor in the tank often enters into the ignitable range.

### SUMMARY OF THE INVENTION

In view of the above problems inherent in the prior art, it is an object of the present invention to provide a structure of a fuel tank for a multi-fuel system that uses a plurality of fuels having different saturated vapor pressures being capable of preventing the formation of fuel vapor of ignitable concentration in the fuel tanks.

According to the present invention, there is provided a structure of a fuel tank for a multi-fuel system equipped with a plurality of tanks for containing a plurality of liquid fuels having different saturated vapor pressures, at least one of the tanks being a high vapor pressure fuel tank which contains a fuel, the saturated vapor pressure thereof being high so that the concentration of fuel vapor in a vapor space of the tank in the normal temperature range becomes higher than an upper-limit of an ignitable concentration of vapor, and at least one of the tanks being a low vapor pressure fuel tank which contains a fuel, the saturated vapor pressure thereof being low so that the concentration of fuel vapor in vapor space of the tank in the normal temperature range becomes lower than the upper-limit of an ignitable concentration of vapor, wherein the vapor space of the high vapor pressure fuel tank communicates with the vapor space of the low vapor pressure fuel tank, and a canister for adsorbing the fuel vapor communicates with the vapor space of the low vapor pressure fuel tank.

Namely, in the present invention, the vapor space in the high vapor pressure fuel tank communicates with the vapor space in the low vapor pressure fuel tank, and the canister communicates with the vapor space in the low vapor pressure fuel tank. Therefore, the fuel vapor in the high vapor pressure fuel tank flows into the vapor space in the low vapor pressure fuel tank, and then flows into the canister.

Therefore, the vapor of fuel having a high saturated vapor pressure flows into the vapor space in the low vapor pressure fuel tank and, hence, the vapor space in the low vapor pressure fuel tank is filled with fuel vapor of a high saturated vapor pressure. Accordingly, the fuel concentration in the vapor space in the low vapor pressure fuel tank becomes nearly equal to the fuel concentration in the vapor space in the high vapor pressure fuel tank; i.e., the vapor space in the low vapor pressure fuel tank assumes a fuel concentration higher than a range of ignitable concentration like the vapor space in the high vapor pressure fuel tank, preventing the fuel vapor from catching fire in the vapor space in the low vapor pressure fuel tank.

Further, in the present invention, the canister and the low vapor pressure fuel tank can be connected via a check valve that permits only a flow from the low vapor pressure fuel tank toward the canister, thereby to prevent the air flow of from the canister from entering into the low vapor pressure fuel tank.

In this case, even if the pressure in the low vapor pressure fuel tank varies due to changes the temperature, the air is prevented from flowing into the low vapor pressure fuel tank from the canister. Even if the pressure in the tank varies, therefore, no mixture is formed which could catch fire in the vapor space in the low vapor pressure fuel tank.

According to another aspect of the present invention, there is provided a structure of a fuel tank for a multi-fuel system equipped with a plurality of tanks for containing a plurality of liquid fuels having different saturated vapor pressures, at least one of the tanks being a high vapor pressure fuel tank which contains a fuel, the saturated vapor pressure thereof being high so that the concentration of a fuel vapor in a vapor space of the tank in the normal temperature range becomes higher than an upper-limit of an ignitable concentration of vapor, and at least one of the tanks being a low vapor pressure fuel tank which contains a fuel, the saturated vapor pressure thereof being low so that the concentration of a fuel vapor in vapor space of the tank in the normal temperature range becomes lower than the upper-limit of an ignitable concentration of vapor, wherein the low vapor pressure fuel tank is accommodated in the high vapor pressure fuel tank, and the vapor space of the low vapor pressure fuel tank communicates with the vapor space of the high vapor pressure fuel tank.

That is, in this aspect of the present invention, the low vapor pressure fuel tank is accommodated in the high vapor pressure fuel tank, and the vapor spaces of the two tanks communicate with each other. Therefore, the fuel vapor of a high saturated vapor pressure in the high vapor pressure fuel tank flows into the low vapor pressure fuel tank, and the concentration of fuel vapor in the low vapor pressure fuel tank is maintained so as to be higher than the upper-limit value of the range of ignitable concentration. According to this aspect of the invention, further, the low vapor pressure fuel tank is accommodated in the high vapor pressure fuel tank, making it possible to simplify the constitution of the fuel system as a whole and to decrease the space for installation.

According to another aspect of the invention, there is provided a structure of a fuel tank for a multi-fuel system equipped with a plurality of tanks for containing a plurality of liquid fuels having different saturated vapor pressures, at least one of the tanks being a low vapor pressure fuel tank which contains a fuel, the saturated vapor pressure thereof being low so that the concentration of a fuel vapor in a vapor space of the tank in the normal temperature range becomes lower than the upper-limit of an ignitable concentration of vapor, wherein provision is made of heating means for maintaining the concentration of the fuel vapor in the vapor space of the low vapor pressure fuel tank to a value higher than the upper-limit of an ignitable concentration of vapor by raising the temperature of the fuel in the low vapor pressure fuel tank.

In this aspect of the invention, the fuel temperature in the low vapor pressure fuel tank is elevated by heating means. Therefore, the saturated vapor pressure of fuel increases, and the concentration of fuel vapor increases correspondingly in the vapor space in the low vapor pressure fuel tank, thus making it possible to maintain the concentration of fuel vapor in the vapor space in the low vapor pressure fuel tank so as to be greater than the upper-limit of an ignitable concentration.

According to this aspect of the invention, further, the vapor space in the low vapor pressure fuel tank does not communicate with the vapor space in the fuel tank having a different saturated vapor pressure and, hence, fuel of a different kind is prevented from entering into the low vapor pressure fuel tank.

According to another aspect of the invention, there is provided a structure of a fuel tank for a multi-fuel system equipped with a plurality of tanks for containing a plurality of liquid fuels having different saturated vapor pressures, at least one of the tanks being a low vapor pressure fuel tank which contains a fuel, the saturated vapor pressure thereof being low so that the concentration of fuel vapor in a vapor space of the tank in the normal temperature range becomes lower than the upper-limit of an ignitable concentration of vapor, wherein provision is made of pressure-reducing means for maintaining the concentration of fuel vapor in the tank to a value higher than the upper-limit of an ignitable concentration of vapor by lowering the pressure in the low vapor pressure fuel tank.

That is, in this aspect of the invention, the pressure of the vapor space in the low vapor pressure fuel tank is lowered by pressure-reducing means so as to increase the concentration of fuel vapor. The concentration of fuel in the vapor space in the fuel tank increases in proportion to a ratio of the partial pressure of the fuel vapor (saturated vapor pressure of fuel) and the total pressure in the tank.

When there is no change in temperature, on the other hand, the saturated vapor pressure of fuel is maintained constant, irrespective of a change in the total pressure in the tank. Therefore, if the total pressure in the tank is lowered by reducing the pressure in the tank while maintaining the fuel temperature constant, the ratio of the partial pressure of the fuel vapor and the total pressure in the tank increases, and therefore the concentration of the fuel vapor is increased.

In this aspect of the invention, the pressure in the low vapor pressure fuel tank is lowered by pressure-reducing means in order to increase the concentration of fuel in the vapor space in the tank. It is therefore possible to maintain the concentration of fuel at a value higher than the upper-limit of the range of ignitable concentrations without increasing the fuel temperature.

According to another aspect of the invention, there is provided a structure of a fuel tank for a multi-fuel system equipped with a plurality of tanks for containing a plurality of liquid fuels having different saturated vapor pressures, at least one of the tanks being a low vapor pressure fuel tank which contains a fuel, the saturated vapor pressure thereof being low so that the concentration of fuel vapor in a vapor space of the tank in a normal temperature range becomes lower than the upper-limit of an ignitable concentration of vapor, wherein provision is made of variable volume means for adjusting the volume of the low vapor pressure fuel tank in such a manner that the entire inner volume of the low vapor pressure fuel tank is filled with the liquid fuel without any vapor space being formed.

That is, in this aspect of the invention, the volume of the low vapor pressure fuel tank is increased or decreased, depending upon the amount of fuel in the tank, so that no vapor space is formed in the tank. Therefore, no mixture is formed of air and fuel vapor in the tank, and thus the fuel vapor is prevented from catching fire.

According to the present invention, as explained above, the formation of a mixture of air and fuel of a concentration that could catch fire in a low vapor pressure fuel tank can be prevented.

### BRIEF DESCRIPTION OF THE DRAWINGS

The present invention will be better understood from the description as set forth hereinafter, with reference to the accompanying drawings, in which:

FIG. 1 is a diagram illustrating the constitution of the present invention when it is applied to a multi-fuel system for an automobile;

FIG. 2 is a diagram illustrating a schematic constitution of an embodiment of the present invention;

FIG. 3 is a diagram illustrating a schematic constitution of an embodiment of the present invention;

FIG. 4 is a diagram illustrating a schematic constitution of an embodiment of the present invention;

FIG. 5 is a diagram illustrating a schematic constitution of an embodiment of the present invention;

FIG. 6 is a diagram illustrating a schematic constitution of an embodiment of the present invention;

FIG. 7 is a diagram illustrating a schematic constitution of an embodiment of the present invention and,

FIG. 8 is a diagram illustrating a schematic constitution of an embodiment of the present invention.

### DESCRIPTION OF THE PREFERRED EMBODIMENT

An embodiment of the invention will now be explained with reference to the accompanying drawings.

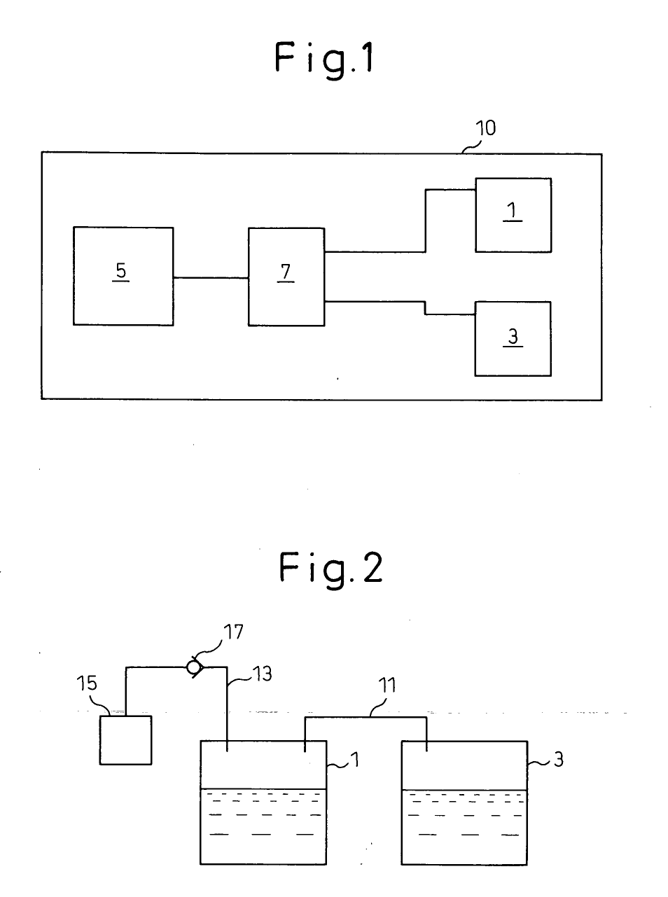

FIG. 1 is a diagram illustrating a schematic constitution of a multi-fuel system for mounting on a vehicle according to the present invention.

In FIG. 1, the multi-fuel system is configured such that a material fuel tank 5, a fuel separator 7, a high-octane fuel tank 1 and a low-octane fuel tank 3 are mounted on a vehicle 10.

In the multi-fuel system of this embodiment, commercially available regular gasoline is separated through the fuel separator 7 into a high-octane fuel containing much of those components having high octane values and a low-octane fuel containing much of those components having low octane values, and these fuels are fed into an internal combustion engine of a vehicle in accordance with the operating conditions of the vehicle.

Commercially available regular gasoline is supplied into the material fuel tank 5 at, for example, a gas station, and is separated into high-octane fuel and low-octane fuel through the fuel separator 7 while the vehicle is in operation. The high-octane fuel that is separated is stored in the high-octane fuel tank 1, and the low-octane fuel is stored in the low-octane fuel tank 3, respectively, which are then fed into the internal combustion engine (not shown) in the vehicle from the tanks 1 and 3, depending upon the operating conditions.

As the fuel separator 7 in this embodiment, for example, a pervaporation membrane type separator, or a fractional distillation type separator utilizing a difference in boiling point between the high-octane component and the low-octane component, or any type of separator capable of separating commercially available gasoline into high-octane fuel and low-octane fuel can be used.

In the case of the multi-fuel system as shown in FIG. 1, however, a problem often occurs in the high-octane fuel tank 1.

In general, high-octane components in the gasoline have boiling points higher than those of low-octane components, and have lower saturated vapor pressures than those of the low-octane components at the same temperature.

Therefore, the high-octane fuel after being separated has a lower saturated vapor pressure than that of the regular gasoline while, conversely, the low-octane fuel has a higher saturated vapor pressure than that of the regular gasoline.

As described above, regular gasoline has a relatively high saturated vapor pressure. In a normal temperature range experienced by a vehicle, therefore, a mixture having a high fuel concentration is formed in space above the liquid level (vapor space) in the fuel tank 5, and the fuel concentration of the mixture becomes higher than the upper-limit of an ignitable concentration. Therefore, there is no probability that the mixture will catch fire in the vapor space in the tank 5.

However, the high-octane fuel separated from the material fuel through the fuel separator 7 has a saturated vapor pressure lower than that of the regular gasoline. In the vapor space in the high-octane fuel tank 1, therefore, the fuel concentration of the mixture becomes lower than that of the mixture in the material fuel tank 5, and a mixture of a fuel concentration that can catch fire at normal temperature is often formed in the high-octane fuel tank 1.

In the case of commercially available high-octane gasoline as described earlier, the blended components can be adjusted in advance so as to increase the saturated vapor pressure without lowering the octane value. However, when high-octane fuel is formed by separating commercially available regular gasoline by the onboard fuel separating system as in the multi-fuel system of FIG. 1, it becomes difficult to adjust the saturated vapor pressure of fuel after being separated.

Therefore, the multi-fuel system shown in FIG. 1 is accompanied by a problem in that it is difficult to prevent a mixture of an ignitable concentration from being formed in the vapor space in the high-octane fuel tank.

According to this embodiment, it is attempted to prevent the formation of a mixture of air and fuel vapor of an ignitable concentration in the high-octane fuel tank 1 by any one or more of the methods of the following embodiments.

The description of the following embodiments does not indicate the portions that are not directly related to the invention, such as the material fuel tank 5 and the fuel separator 7 in the constitution shown in FIG. 1, but indicates only the high-octane fuel tank (i.e., low vapor pressure fuel tank) 1 and the low-octane fuel tank (i.e., high vapor pressure fuel tank) 3.

In the drawings, further, the same reference numerals denote the same elements.

### (1) First Embodiment

FIG. 2 illustrates a schematic constitution of a first embodiment of the present invention.

In this embodiment, a communication pipe 11 is provided for connecting a vapor space above the liquid level in the high-octane fuel tank 1 to the vapor space in the low-octane fuel tank 3. The vapor space in the high-octane fuel tank 1 is further connected to a canister 15 through a vapor pipe 13.

The canister 15 is equipped with an adsorbent such as activated carbon which adsorbs the fuel vapor that flows in from the high-octane fuel tank 1 through the vapor pipe 13 and prevents it from being emitted to the atmosphere.

The fuel vapor adsorbed by the canister 15 is fed, through a purge pipe that is not shown, to an intake passage of the internal combustion engine of the vehicle, and burns in the combustion chambers of the internal combustion engine.

By providing the communication pipe 11 and the vapor pipe 13 as shown in FIG. 2, the fuel vapor in the low-octane fuel tank 3 having a high saturated vapor pressure flows into the canister 15 from the vapor pipe 13 passing through the vapor space in the high-octane fuel tank 1.

Therefore, the vapor space in the high-octane fuel tank 1 is filled with fuel vapor having a high saturated vapor pressure from the low-octane fuel tank 3. The saturated vapor pressure of fuel in the low-octane fuel tank 3 is higher than the saturated vapor pressure of the material regular gasoline. Therefore, the fuel concentration of a mixture in the vapor space in the high-octane fuel tank 1 becomes higher than the upper-limit of ignitable concentration, and hence the mixture is prevented from catching fire in the vapor space in the high-octane fuel tank 1.

When the pressure decreases in the tanks 1 and 3 due to variation in the atmospheric temperature, air may flow into the high-octane fuel tank 1 from the canister 15 through the vapor pipe 13, and a mixture that can catch fire may be formed in the vapor space. As shown in FIG. 2, therefore, it is desirable to provide the vapor pipe 13 with a check valve 17 that permits only the flow from the tank 1 toward the canister 15 so as to prevent air from entering into the high-octane fuel tank 1.

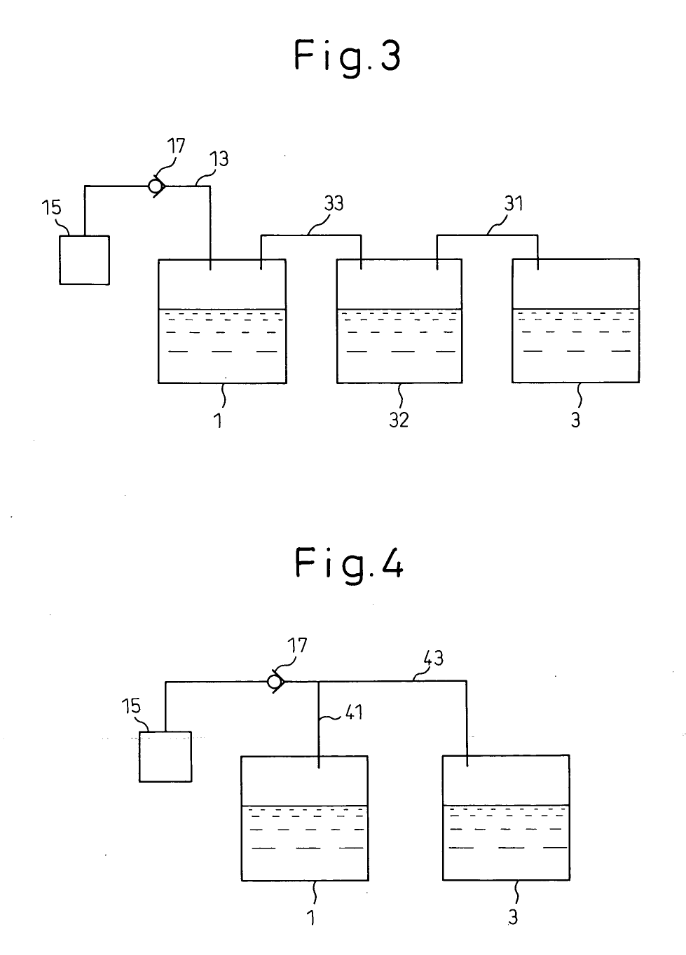

FIG. 3 illustrates a modified example of the embodiment of FIG. 2. In the modification in FIG. 3, in addition to the high-octane fuel tank 1 and the low-octane fuel tank 3, there is provided an intermediate-octane fuel tank 32 for storing fuel having a saturated vapor pressure which is between that of the high-octane fuel and that of the low-octane fuel. The intermediate-octane fuel has a saturated vapor pressure which is higher than that of the high-octane fuel, but is not so high as to maintain the fuel concentration of a vapor space in the tank 32 to be more than the upper-limit of ignitable concentration over the whole range of normal temperatures.

In this case as shown in FIG. 3, communication pipes 31 and 33 are provided so that the fuel vapor in the high-octane fuel tank 1 may flow into the canister 15 passing through the intermediate-octane fuel tank 32 and the high-octane fuel tank 1. Thus, this arrangement makes it possible to maintain the fuel concentrations of the vapor spaces in both the high-octane fuel tank 1 and in the intermediate-octane fuel tank 32 so as to be higher than the upper-limit of ignitable concentration.

FIG. 4 illustrates another modified example of FIG. 2.

In the modification in FIG. 2, the vapor space in the high-octane fuel tank 1 is connected directly to the vapor space in the low-octane fuel tank 3 through the communication pipe 11. In the example of FIG. 4, however, a vapor pipe 43 is provided to connect the canister 15 to the low-octane fuel tank 3, and the vapor pipe 43 is connected to the vapor space in the high-octane fuel tank 1 through a pipe 41. That is, in this embodiment, the pipe 41 works both as the communication pipe 11 and the vapor pipe 13 in FIG. 2.

### (2) Second Embodiment

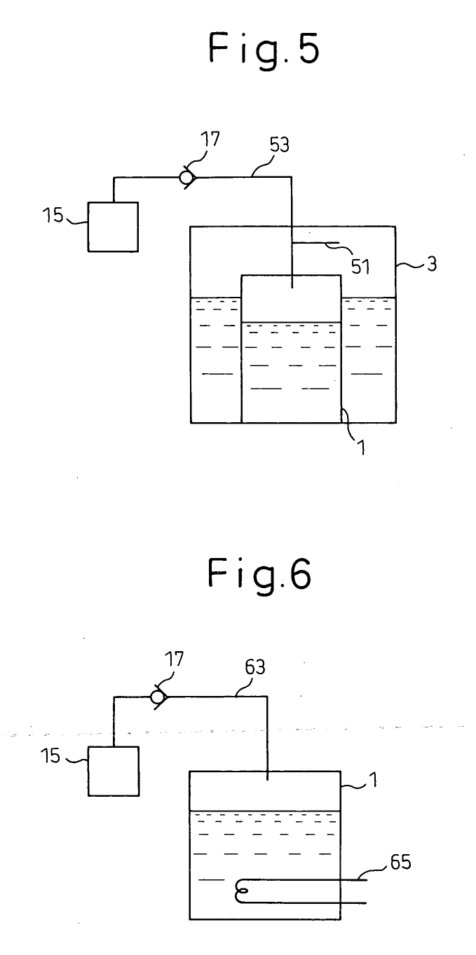

FIG. 5 is a diagram schematically illustrating the constitution according to a second embodiment of the present invention.

In the embodiments of FIGS. 2 to 4 described above, the vapor spaces of the high-octane fuel tank 1 and the low-octane fuel tank 3 are connected by the communication pipe. This embodiment, however, is different from the embodiments of FIGS. 2 to 4 in that the high-octane fuel tank 1 is accommodated in the low-octane fuel tank 3.

In the embodiment of FIG. 5, the high-octane fuel tank 1 accommodated in the low-octane fuel tank 3 is of a sealed structure, and there is provided a vapor pipe 53 that connects the vapor space in the high-octane fuel tank 1 to the canister 15 through the check valve 17. Further, a communication pipe 51 is branched from the vapor pipe 53 and is opened in the vapor space in the low-octane fuel tank 3.

Therefore, the vapor spaces of the high-octane fuel tank 1 and the low-octane fuel tank 3 are connected to each other, and fuel vapor of a high saturated vapor pressure in the vapor space in the low-octane fuel tank 3 flows into the vapor space of the high-octane fuel tank 1. Thus, the formation of a mixture of a concentration in the ignitable range in the high-octane fuel tank 1 does not occur.

Since the high-octane fuel tank 1 is accommodated within the low-octane fuel tank 3 in this embodiment, the space required for installing the fuel tanks, as well as the amounts of pipe works and number of parts, can be reduced compared to the case where separate tanks are used.

### (3) Third Embodiment

FIG. 6 is a diagram schematically illustrating the constitution according to another embodiment of the present invention.

In the embodiments of FIGS. 2 to 5 described above, the vapor space in the high-octane fuel tank 1 communicates with the vapor space in the low-octane fuel tank 3, and the fuel vapor of a high saturated vapor pressure is introduced into the high-octane fuel tank 1 in order to prevent the formation of a mixture of an ignitable concentration in the high-octane fuel tank 1.

This embodiment differs from the embodiments of FIGS. 2 to 5 in that the saturated vapor pressure of fuel in the high-octane fuel tank 1 is increased so as to prevent the formation of a mixture of an ignitable concentration.

In FIG. 6, reference numeral 63 denotes a vapor pipe that connects the vapor space in the high-octane fuel tank 1 to the canister 15 through the check valve 17. In this embodiment, further, a heater 65 is provided in the high-octane fuel tank 1 under the liquid level of fuel in order to heat the fuel.

The heater of any kind, such as an electric heater or a heater that uses a hot medium such as hot water, can be used as the heater of this embodiment, provided it is capable of raising the temperature in the high-octane fuel tank 1 up to a predetermined temperature that will be described later.

In this embodiment, the fuel temperature in the tank 1 is raised by the heater 65 in order to increase the saturated vapor pressure of fuel so that the formation of a mixture of an ignitable concentration in the tank 1 does not occur.

A mixture of air and fuel vapor is always formed in the vapor space in the tank 1. When the pressure remains constant in the tank, the fuel concentration in the mixture increases in proportion to the partial pressure of the fuel vapor in the vapor space, i.e., in proportion to the saturated vapor pressure of the fuel vapor.

As can be seen in FIG. 6, the high-octane fuel tank 1 communicates with the atmosphere through the canister 15 in this embodiment, and hence the pressure in the tank is kept at a constant pressure close to atmospheric pressure. By raising the temperature of the fuel using the heater 65, therefore, the partial pressure of fuel vapor (saturated vapor pressure of fuel) can be increased in the mixture in the vapor space in the tank 1, and the fuel concentration can be maintained so as to be higher than the upper-limit of an ignitable concentration range. Therefore, by raising the fuel temperature in the tank 1 using the heater 65, formation of a mixture of an ignitable concentration in the vapor space in the tank 1 can be avoided.

In this embodiment, further, the vapor space of the high-octane fuel tank 1 does not communicate with the low-octane fuel tank 3. Therefore, it is possible to completely prevent the fuel in either tank from entering into the other tank through the communication pipe, for whatever reason.

The fuel temperature required for preventing the formation of a mixture of ignitable concentration range varies, depending upon the components of the high-octane fuel after being separated. It is therefore preferable that the set point temperature of the heater 65 be determined through experiments using actual high-octane fuels.

### (4) Fourth Embodiment

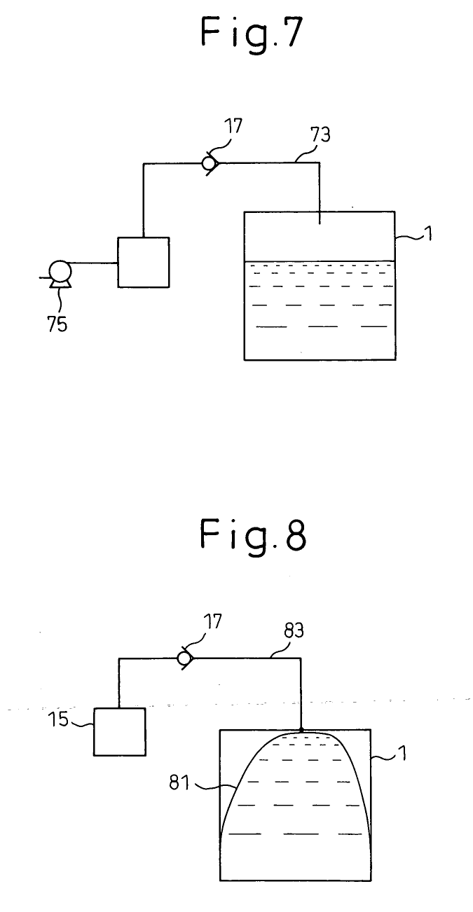

FIG. 7 is a diagram schematically illustrating the constitution of an embodiment of the invention which is different from the above-mentioned embodiments.

In this embodiment, too, the formation of a mixture of an ignitable concentration in the fuel tank 1 is avoided without introducing fuel vapor in the low-octane fuel tank 3 into the vapor space in the high-octane fuel tank 1.

The embodiment of FIG. 7 is the same as the embodiment of FIG. 6 with respect to that the vapor space in the high-octane fuel tank 1 is connected to the canister 15 through a vapor pipe 73 and the check valve 17.

This embodiment, however, is different from the embodiment of FIG. 6 in that the canister 15 is not opened to the atmosphere, but is connected to a vacuum pump 75.

In this embodiment, the formation of a mixture of an ignitable concentration in the vapor space in the tank 1 is avoided by lowering the pressure in the high-octane fuel tank 1 by using the vacuum pump 75.

As described earlier, the partial pressure of fuel vapor in the tank 1 becomes equal to the saturated vapor pressure of fuel, irrespective of the pressure in the tank, and hence becomes nearly constant if the fuel temperature is constant. The fuel concentration of the mixture in the vapor space increases in proportion to the ratio of the partial pressure of fuel vapor and the pressure in the tank 1.

In this embodiment, the total pressure in the tank is lowered by the vacuum pump 75 instead of elevating the partial pressure of fuel vapor, and the pressure in the tank is lowered so as to increase the fuel concentration of the mixture in the vapor space in the tank 1.

Therefore, this embodiment makes it possible to obtain the same effect as that of the embodiment of FIG. 6 without using heater.

### (5) Fifth Embodiment

FIG. 8 is a diagram schematically illustrating the constitution of another embodiment of the present invention.

This embodiment is different from the embodiments explained above in that no vapor space is formed above the liquid fuel level in the tank 1.

In this embodiment as shown in FIG. 8, a flexible and expansible membrane or bag (bladder) 81 is provided in the high-octane fuel tank 1, and fuel is contained inside the bladder 81.

Further, a vapor pipe 83 is connected to the top of the bladder 81 for connecting the interior of the bladder 81 to the canister 15 through the check valve 17. In this embodiment, the vapor pipe 83 is used for venting air in case air has entered into the bladder. Further, in the case where the fuel temperature in the bladder 81 rises and the saturated vapor pressure becomes higher than atmospheric pressure, fuel vapor is formed in the upper part of the bladder 81. However, this fuel vapor is guided into the canister 15 through the vapor pipe 83 in this embodiment.

The bladder 81 expands and contracts to meet an increase or decrease of fuel therein, and hence the fuel always fills the entire volume of the bladder 81 without vapor space being formed therein.

In this embodiment, therefore, since no mixture of air and fuel vapor is formed in the tank 1, there is no possibility of the mixture catching fire, irrespective of the saturated vapor pressure of the fuel.

Though this embodiment uses a diaphragm or the bladder as variable volume means for varying the tank volume, depending upon an increase or a decrease in the fuel in the tank, any other means may be used, such as a moving separator wall as variable volume means.

1. A structure of a fuel tank for a multi-fuel system equipped with a plurality of tanks for containing a plurality of liquid fuels having different saturated vapor pressures, at least one of the tanks being a high vapor pressure fuel tank which contains a fuel, a saturated vapor pressure thereof being high so that the concentration of fuel vapor in a vapor space of the tank in the normal temperature range becomes higher than an upper-limit of an ignitable concentration of vapor, and at least one of the tanks being a low vapor pressure fuel tank which contains a fuel, a saturated vapor pressure thereof is low so that the concentration of fuel vapor in vapor space of the tank in the normal temperature range becomes lower than the upper-limit of an ignitable concentration of vapor, wherein the vapor space of the high vapor pressure fuel tank communicates with the vapor space of the low vapor pressure fuel tank, and a canister for adsorbing the fuel vapor communicates with the vapor space of the low vapor pressure fuel tank.

2. A structure of a fuel tank for a multi-fuel system equipped with a plurality of tanks for containing a plurality of liquid fuels having different saturated vapor pressures, at least one of the tanks being a high vapor pressure fuel tank which contains a fuel, a saturated vapor pressure thereof being high so that the concentration of fuel vapor in a vapor space of the tank in the normal temperature range becomes higher than an upper-limit of an ignitable concentration of vapor, and at least one of the tanks being a low vapor pressure fuel tank which contains a fuel, a saturated vapor pressure thereof being low so that the concentration of fuel vapor in a vapor space of the tank in a normal temperature range becomes lower than the upper-limit of an ignitable concentration of vapor, wherein the low vapor pressure fuel tank is accommodated in the high vapor pressure fuel tank, and the vapor space of the low vapor pressure fuel tank communicates with the vapor space of the high vapor pressure fuel tank.

3. A structure of a fuel tank for a multi-fuel system equipped with a plurality of tanks for containing a plurality of liquid fuels having different saturated vapor pressures, at least one of the tanks being a low vapor pressure fuel tank which contains a fuel, a saturated vapor pressure thereof being low so that the concentration of fuel vapor in a vapor space of the tank in the normal temperature range becomes lower than the upper-limit of an ignitable concentration of vapor, wherein provision is made of heating means for maintaining the concentration of the fuel vapor in the vapor space of the low vapor pressure fuel tank to a value higher than the upper-limit of an ignitable concentration of vapor by raising the temperature of the fuel.

4. A structure of a fuel tank for a multi-fuel system equipped with a plurality of tanks for containing a plurality of liquid fuels having different saturated vapor pressures, at least one of the tanks being a low vapor pressure fuel tank which contains a fuel, a saturated vapor pressure thereof being low so that the concentration of fuel vapor in a vapor space of the tank in the normal temperature range becomes lower than the upper-limit of an ignitable concentration of vapor, wherein provision is made of pressure-reducing means for maintaining the concentration of fuel vapor in the tank to a value higher than the upper-limit of an ignitable concentration of vapor by lowering the pressure in the low vapor pressure fuel tank.

5. A structure of a fuel tank for a multi-fuel system equipped with a plurality of tanks for containing a plurality of liquid fuels having different saturated vapor pressures, at least one of the tanks being a low vapor pressure fuel tank which contains a fuel, a saturated vapor pressure thereof being low so that the concentration of fuel vapor in a vapor space of the tank in the normal temperature range becomes lower than the upper-limit of an ignitable concentration of vapor, wherein provision is made of variable volume means for adjusting the volume of the low vapor pressure fuel tank in such a manner that the entire inner volume of the low vapor pressure fuel tank is filled with the liquid fuel without any vapor space being formed.

6. A structure of a fuel tank for a multi-fuel system according to claim 1, wherein said canister and the low vapor pressure fuel tank are connected via a check valve that permits only the flow from the low vapor pressure fuel tank toward the canister, thereby to prevent a flow of air from the canister from entering into the low vapor pressure fuel tank.
